(19) United States
(12) Patent Application Publication
(10) Pub. No.: US 2016/0117396 A1
(43) Pub. Date: Apr. 28, 2016

(54) NEED TO KNOW SEARCH RESULTS

(71) Applicant: International Business Machines Corporation, Armonk, NY (US)

(72) Inventor: Amy D. Travis, Arlington, MA (US)

(21) Appl. No.: 14/520,597

(22) Filed: Oct. 22, 2014

(51) Int. Cl. G06F 17/30

(52) U.S. Cl. CPC G06F 17/30867

(57) ABSTRACT

Methods and apparatus, including computer program products, implementing and using techniques for searching for assets in a resource. In response to determining that metadata associated with a received query for one or more assets in the resource fulfills a predetermined criterion, a response is provided to the query. The response includes one or more assets that are tagged in the resource as hidden assets.

### BACKGROUND

The present invention relates to search queries, and more specifically, to determining what results to display to a user in response to receiving a search query from the user.

In corporate environments, there are often assets, such as files, team spaces, or communities that are hidden from the general set of employees, but which should be found by people in particular positions within the company or by people having a particular expertise. For example, the IBM Connections product, which is available from International Business Machines Corporation of Armonk, N.Y., is an online social networking platform for business use. One of the features of the IBM Connections product is online Connections communities, which can be described as an online “team space” where content is shared among the members of the community. Sometimes these communities are “restricted,” that is, the connections community cannot be found by anyone who is not currently a member of the community.

However, with these restricted communities, if a person is supposed to know about them, but is not yet a member, that person is not able to find the restricted community. As a result, the person must rely on other people remembering to give him/her access to the restricted community. Similar situations may come up in any sort of tool that restricts data, such as meeting rooms, chat rooms, and so on.

### SUMMARY

According to one embodiment of the present invention, methods and apparatus are provided, including computer program products, implementing and using techniques for searching for assets in a resource. In response to determining that metadata associated with a received query for one or more assets in the resource fulfills a predetermined criterion, a response is provided to the query. The response includes one or more assets that are tagged in the resource as hidden assets.

The details of one or more embodiments of the invention are set forth in the accompanying drawings and the description below. Other features and advantages of the invention will be apparent from the description and drawings, and from the claims.

### BRIEF DESCRIPTION OF THE SEVERAL VIEWS OF THE DRAWINGS

FIG. 1 shows a system (100) for performing searches, in accordance with one embodiment.

FIG. 2 shows a process (200) for performing searches, in accordance with one embodiment.

FIG. 3 shows a screenshot of a user interface for tagging an asset as not findable, in accordance with one embodiment.

FIG. 4 shows a screenshot of a user interface for tagging an asset as restricted, in accordance with one embodiment.

Like reference symbols in the various drawings indicate like elements.

### DETAILED DESCRIPTION

It is quite common for modern search engines to provide secured search mechanisms that prevent unauthorized users from searching for and discovering content to which they do not have access. Some search engines allow a search administrator to relax this binary result (i.e., either the user sees the document or not), with the ability for a user to see whether a document exists in the search results but being denied access when the user clicks on the document to view or use it. Other search engines do not even let the user know that a document exists in the search results.

In either case, the techniques described herein enable a “middle ground” for those assets that can be discoverable by users who match a particular set of conditions determined by the assets owner. That is, the techniques described herein go beyond conventional access control schemes that employ user-based, group-based, or role-based access control, to include more rule-based conditions.

The following are some examples of potential rules that could be used to allow or prohibit discovery of a given asset:
User tagged with “manager.”
User with at least 15 direct reports.
User who is a direct connection to 5 or more people who have access to this asset.
   It should be noted that these examples are by no way exclusive, and that those having ordinary skill in the art can come up with many different rules that are appropriate in different situations.

In some embodiments, this type of information can be gleaned from, for example, an LDAP (Lightweight Directory Access Protocol) directory, or from social networking information. The information can then be used to determine whether to disclose otherwise hidden assets, based on matches between the asset and the person searching.

In addition, the person marking the content as “not searchable” could, for example, indicate what attributes would make the content findable, whether it be a job role, hierarchy in the organization, location, number of contacts in common with the people who have access, and so on, including combinations of one or more of these attributes. Various embodiments of the invention will now be described in further detail by way of example, and with reference to the figures.

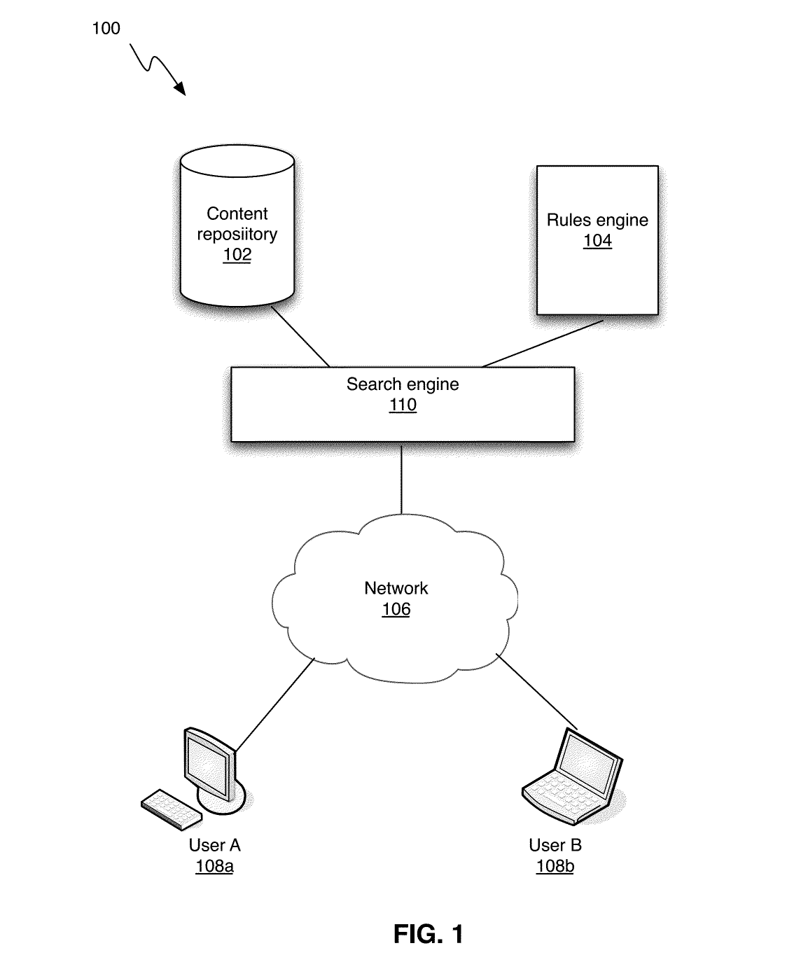

FIG. 1 shows an overview of a system 100 in which the various embodiments of the invention can be implemented. As can be see in in FIG. 1, the system 100 includes a content repository 102, a rules engine 104, a computer network 106, a search engine 110 and user devices 108a and 108b. For ease of illustration, the content repository 102 is represented in FIG. 1 as a single server, but as the skilled person realizes, any number of local or remote servers, repositories or other storage devices that are capable of storing digital content and that are accessible and searchable through networks such as intranets or the Internet can be included in the concept of a content repository 102.

The content repository 102 will be described herein by way of example and with reference to a server in a corporate environment, storing corporate documents that employees or other users may wish to access from time to time. In some embodiments, the content repository 102 can contain information in addition to the documents, such as, forums, wiki pages, media (e.g., videos), schedules, to-do lists, etc.

The rules engine 104 contains the rules, which are typically set up by a system administrator, for accessing the content of the content repository 102. As was mentioned above, the rules can be based on essentially any criteria that can be set up by the system administrator. For example, the conventional access control schemes, such as user-based, group-based, or role-based access control to the content in the content repository 102 can be used. However, more importantly, a system administrator can set up other types of conditions to allow or prohibit access to assets in the content repository 102, for example, based on a user who is tagged as a “manager,” a user with at least 15 direct reports, or a user who is a direct connection to five or more people who have access to a particular asset. Other examples can include users who have received a particular type of training, users who has a particular certification, users who attended a particular meeting, users who are located in a particular office, users who had access to another piece of content, user who signed a particular “permissions” form, such as a non-disclosure agreement, etc. As the skilled person realizes, there is a wide variety of options for controlling access to the content repository 102.

The network 106 can be any type of wired or wireless network that is capable of communicating with the user devices 108a and 108b and transfer search queries from the user devices 108a, 108b (such as computers, cell phones, tablets, etc.), to the search engine 110. The search engine 110 communicates with the content repository 102 and the rules engine 104, either directly, or through some kind of wired or wireless network. The search engine 110 receives search queries from the user devices 108a, 108b, communicates with the rules engine 104 and the content repository 102 and presents the results from the search query to the user devices 108a, 108b, in accordance with the rules specified by the rules engine 104.

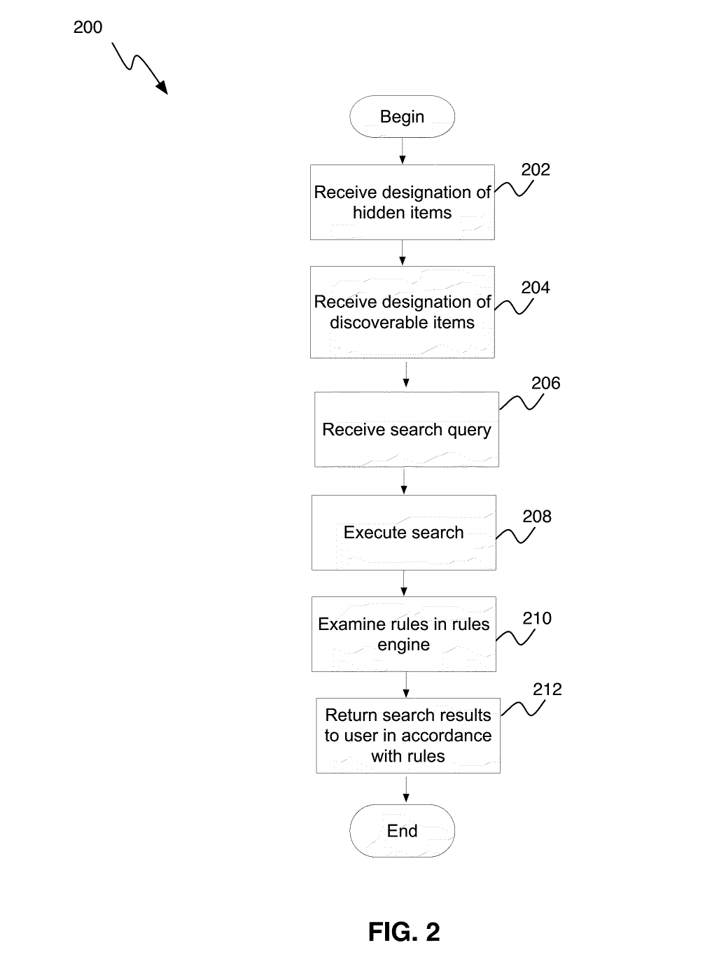

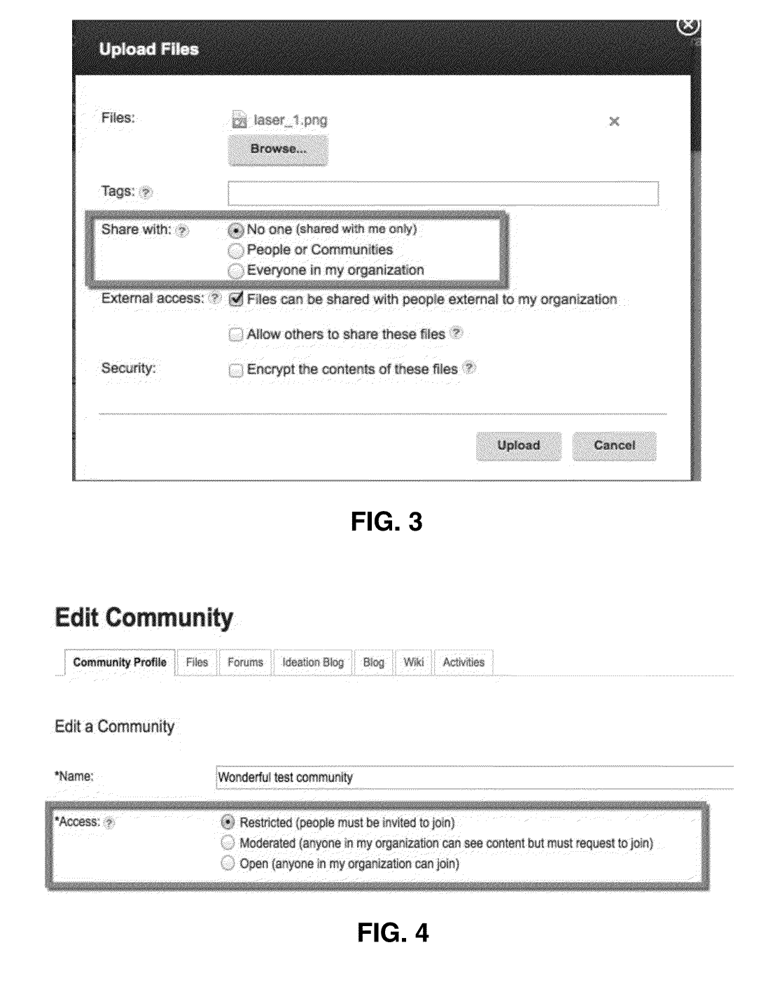

FIG. 2 is a flowchart showing a process 200 for presenting search results to a user on a need-to-know basis, in accordance with one embodiment of the invention. As can be seen in FIG. 2, the process 200 starts by a content owner or administrator who is responsible for the searchable content marking one or more items in the content repository 102 as “not findable,” using capabilities already inherent in a tool (step 202). Some examples of a user interface allowing a user to mark a specific piece of content as restricted or no findable are shown in FIGS. 3 and 4. As can be seen in these figures, the user can simply check a radio button on the user interface in order to mark whether the piece of content should be found or no.

FIG. 3 shows how to mark a piece of content as not findable, and FIG. 4 shows how to mark an online community as not findable. For example, in the Connections Product, this could be a restricted community. Another example is the Sametime Product, also available from International Business Machines Corporation, which is an instant messaging, video conferencing, and online meeting service. In the Sametime product, the hidden asset can be, for example, a hidden meeting room. As will be described in further detail below, in the case of Connections Product, users find the restricted community by searching. In the Sametime product, the hidden meeting room can be found only if the user types the exact string of the meeting room name into a web browser. Of course, as the skilled person realizes, the techniques described herein are not limited to be implemented in the Connections product and the Sametime product, but can be applied to essentially any situation in which access to content, communities, etc., may need to be restricted.

Next the content owner or administrator marks one or more objects in the content repository as “findable,” using similar capabilities already inherent in a tool (step 204). In one embodiment, the marking of the content in steps 202 and 204 can be done by adding an extension to the content, which marks under what circumstances the content should be finable vs. not findable. In an alternative embodiment, the content is not marked by a user, but instead the system 100 generates its own matching criteria, for example, by picking keywords from an item being searched for, and matching those keywords to tags associated with the user doing the search.

After some time a search query is received from a user 108a, 108b, by the search engine 110 (step 206). The search engine 110 executes the query (step 208), examines the rules in the rules engine 104 (step 210), and returns only the items that should not be hidden to the user (step 212) in accordance with the rules in the rules engine 104, which ends the process (200).

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1-6. (canceled)

7. A computer program product for searching for assets in a resource, the computer program product comprising a computer readable storage medium having program instructions embodied therewith, wherein the computer readable storage medium is not a transitory signal per se, the program instructions being executable by a processor to cause the processor to perform a method comprising:
in response to determining that metadata associated with a received query for one or more assets in the resource fulfills a predetermined criterion, providing a response to the query, wherein the response includes one or more assets that are tagged in the resource as hidden assets.

8. The computer program product of claim 7, wherein the assets represent one or more of: files, online team spaces, online communities, online chat rooms, online meeting rooms, online forums, wiki pages, memberships in an online space, and metadata in a document.

9. The computer program product of claim 7, wherein the metadata represents one or more of: user data, a job role for a user, an expertise of a user, other users to whom the user is connected, a certification of a user, an attendance at an online meeting by a user, a completion of a training course for a user and a signature on a permissions form by a user.

10. The computer program product of claim 7, wherein the metadata is obtained from one or more of: a Lightweight Directory Access Protocol directory, and social networking information.

11. The computer program product of claim 7, further comprising: tagging one or more assets in the resource as hidden assets, wherein the tagging includes indicating attributes that make the tagged assets searchable.

12. The computer program product of claim 11, wherein determining that metadata associated with a received query for one or more assets in the resource fulfills a predetermined criterion includes:
comparing the metadata with the attributes that make the tagged assets searchable.

13. A system for searching for assets in a resource, comprising:
a content repository storing one or more assets, wherein at least some of the assets are tagged as hidden assets;
a rules engine containing rules defining access rules for users to individual assets in the content repository; and
a search engine including a memory and a processor, the search engine being configured to:
receive a query for assets in the content repository, wherein the query includes metadata about the user submitting the query;
search the content repository based on the received query;
for each asset resulting from the search, determine, based on the received metadata and the access rules in the rules engine, whether the asset should be findable by the user; and
returning only those assets that should be findable to the user in response to the user query.

14. The system of claim 13, wherein the assets represent one or more of: files, online team spaces, online communities, online chat rooms, online meeting rooms, online forums, wiki pages, memberships in an online space, and metadata in a document.

15. The system of claim 13, wherein the metadata represents one or more of: user data, a job role for a user, an expertise of a user, other users to whom the user is connected, a certification of a user, an attendance at an online meeting by a user, a completion of a training course for a user and a signature on a permissions form by a user.

16. The system of claim 13, wherein the metadata is obtained from one or more of: a Lightweight Directory Access Protocol directory, and social networking information.

17. The system of claim 5, wherein determining whether an asset should be findable includes:
comparing the metadata with attributes that make the tagged assets searchable.
